(19) United States
(12) Patent Application Publication
(10) Pub. No.: US 2012/0163310 A1
(43) Pub. Date: Jun. 28, 2012

(54) APPARATUS FOR ALLOCATING PHYSICAL RESOURCES

(75) Inventors: Young Seok BAEK, Daejeon (KR); Jin Kyu Kim, Daejeon (KR); Byung Jo Kim, Daejeon (KR); Bon Tae Koo, Daejeon (KR)

(73) Assignee: Electronics and Telecommunications Research Institute, Daejeon (KR)

(21) Appl. No.: 13/310,599

(22) Filed: Dec. 2, 2011

(30) Foreign Application Priority Data
Dec. 23, 2010 (KR) 10-2010-0133261

(51) Int. Cl. H04W 72/04

(52) U.S. Cl. 370/329

(57) ABSTRACT

A apparatus for allocating physical resources at high speed includes: a storage unit storing correspondence relationships between virtual resource blocks and physical resource blocks according to external variables and internal variables; an internal variable calculation unit receiving the external variables for allocating physical resource blocks and calculating internal variables determined by the received external variables; and a searching unit referring to the storage unit by using the received external variables and allocating physical resources corresponding to the virtual resource blocks.

### CROSS-REFERENCE TO RELATED APPLICATIONS

This application claims the priority of Korean Patent Application No. 10-2010-0133261 filed on Dec. 23, 2010, in the Korean Intellectual Property Office, the disclosure of which is incorporated herein by reference.

### BACKGROUND OF THE INVENTION

1. Field of the Invention

The present invention relates to an apparatus for allocating physical channel resources for a mobile communications system and, more particularly, to a resource distribution apparatus for distributing various physical channels in frequency and time resources at high speed in applying an orthogonal frequency division multiplexing (OFDM) modulation scheme used in a next-generation mobile communications system.

2. Description of the Related Art

Mobile communications technology is evolving from an existing CDMA scheme toward an orthogonal frequency-division multiple access (OFDMA) scheme, exhibiting excellent effects in terms of symbol interference or user multiplexing, and a mapping method for effectively disposing physical resources is also advancing in tandem therewith.

A scheme for distributing physical resources in downlinking and uplinking in long term evolution (LTE), a scheme which has come to prominence as a next-generation mobile communications standard, is a mixture of a time division duplex (TDD) scheme (or a time division multiplexing scheme) and a frequency division duplex (FDD) scheme (or frequency division multiplexing scheme).

TDD is a scheme for performing alternate bi-directional transmission on a time axis by using an identical frequency band in uplinking and downlinking, and FDD is a scheme for allocating mutually different frequency bands for a signal transmission in uplinking and downlinking and transmitting signals in a pair of frequency bands discriminated by a certain guard band.

Namely, LTE uses a scheme in which data is carried in respective frequency-divided physical resources within a time-divided time band and transmitted.

In detail, downlinking and uplinking is comprised of radio frames each having a period of 10 ms, and each of the radio frames is comprised of a total of 10 subframes each having a period of 1 ms.

A medium access control (MAC) layer controlling a physical layer manages data transmission and reception by subframe. One subframe is comprised of two slots, and each of the slots has a time period of 0.5 ms. Each of the slots is comprised of several resource blocks, and each of the resource blocks is comprised of three, six, or seven OFDM symbols on a time axis and twelve or twenty-four resource elements on a frequency axis. Twelve or twenty-four resource elements are frequency resources corresponding to 180 KHz. The number of resource blocks constituting each slot is determined according to a transmission system bandwidth. In general, a slot may be comprised of 6 (1.4 MHz), 15 (3 MHz), 25 (5 MHz), 50 (10 MHz), 75 (15 MHz), 100 (20 MHz) resource blocks.

Thus, one radio frame is comprised of a total of ten subframes, or twenty slots, while 0 to 9 are used as subframe numbers, and 0 to 19 are used as slot numbers.

As for an allocation of resource blocks, a scheme for allocating resources in a distributed manner in consideration of a channel environment has been proposed. The use of this scheme, however, has a problem in which every calculation must be performed within 1 msec in terms of a communication standard in allocating physical resources by using a plurality of numerical formulas.

### SUMMARY OF THE INVENTION

An aspect of the present invention provides an apparatus for effectively allocating physical resources at high speed.

According to an aspect of the present invention, there is provided an apparatus for allocating physical resources, including: a storage unit storing correspondence relationships between virtual resource blocks and physical resource blocks according to external variables and internal variables; an internal variable calculation unit receiving the external variables for allocating physical resource blocks and calculating internal variables determined by the received external variables; and a searching unit referring to the storage unit by using the received external variables and allocating physical resources corresponding to the virtual resource blocks.

The apparatus for allocating physical resources may be an apparatus for obtaining LTE/LTE Advanced physical resources, and the internal variable calculation unit may generate the number of rows (Nrow) and the number of nulls (Nmull) in interleaving units.

The storage unit may be implemented as a read only memory (ROM) or a random logic.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic functional block diagram of an apparatus for allocating physical resources according to an embodiment of the present invention;

FIG. 2 is a view showing the apparatus for allocating physical resources according to an embodiment of the present invention, expressed as functions;

FIG. 3 is a schematic view showing a scheme for allocating physical resources by the apparatus for allocating physical resources according to an embodiment of the present invention; and

FIG. 4 is a view showing a storage unit of the apparatus for allocating physical resources according to an embodiment of the present invention, implemented by hardware.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like components.

Unless explicitly described to the contrary, the word “comprise” and variations such as “comprises” or “comprising,” will be understood to imply the inclusion of stated elements but not the exclusion of any other elements.

The present invention proposes an apparatus for receiving an external variable to generate an internal variable, in a state in which physical block values corresponding to the entire ranges of virtual blocks are configured as a table, and obtain a physical resource block with respect to a virtual resource block with reference to the table, thus quickly obtaining physical resources. According to the scheme, physical resources can be obtained from virtual resources only through a onetime reference, whereby a time required for obtaining information regarding a desired physical resource block can be reduced.

A process of deriving a physical resource block from virtual resource blocks will be briefly described before constituent devices of the present invention are explained.

In a standard (e.g., LTE/LTE Advanced) of a recent mobile communications system employing OFDMA, resources are allocated in a distributed manner, and a physical resource block is obtained from virtual resource blocks. Hereinafter, a process of obtaining a physical resource block from respective virtual resource blocks will be described.

Table 1 below shows a relationship between the number of resource blocks N_{RB}^{DL} and a gap value N_{gap}.

[symbol]

1

Gap (N_{gap})

| Resource block | 1^{st} gap | 2^{nd} gap |
|---|---|---|
| (N_{RB}^{DL}) | (N_{gap, 1}) | (N_{gap, 2}) |
| 6-10 | ┌N_{RB}^{DL}/2┐ | N/A |
| 11 | 4 | N/A |
| 12-19 | 8 | N/A |
| 20-26 | 12 | N/A |
| 27-44 | 18 | N/A |
| 45-49 | 27 | N/A |
| 50-63 | 27 | 9 |
| 64-79 | 32 | 16 |
| 80-110 | 48 | 16 |

In the case of 6≦N_{RB}^{DL}≦49, only one gap value N_{gap,1} is defined, and here, N_{gap}=N_{gap,1}. In the case of 50≦N_{RB}^{DL}≦110, two gap values N_{gap,1} and N_{gap,2} are defined. Here, whether or not N_{gap}=N_{gap,1} or whether or not N_{gap}=N_{gap,2} is determined according to the results of a downlink scheduling allocation of an upper layer.

Distribution type virtual resource blocks are numbered from 0 to N_{VRB}^{DL}−1, and here, N_{VRB}^{DL} is defined as expressed by Equation 1 shown below:

N_{VRB}^{DL}=N_{VRB,gap1}^{DL}=2·min(N_{gap},N_{RB}^{DL}−N_{gap}),N_{gap}=N_{gap,1}

N_{VRB}^{DL}=N_{VRB,gap2}^{DL}=└N_{RB}^{DL}/2N_{gap}┘·2N_{gap},N_{gap}=N_{gap,2} [Equation 1]

Before matching virtual resource blocks to physical resource blocks, the virtual resource blocks are interleaved. In order to perform the interleaving operation, a certain number of virtual resource blocks are collected to form interleaving units, and the interleaving units are interleaved. Here, the interleaving units are formed by disposing virtual resource blocks in a certain structure.

When an LTE/LTE-Advanced system is taken as an example, Ñ_{VRB}^{DL} number of successive virtual resource blocks form an interleaving unit. Here, Ñ_{VRB}^{DL} is defined as expressed by Equation 2 shown below:

Ñ_{VRB}^{DL}=N_{VRB}^{DL},N_{gap}=N_{gap,1}

Ñ_{VRB}^{DL}=2N_{gap},N_{gap}=N_{gap,2} [Equation 2]

The interleaving unit comprised of Ñ_{VRB}^{DL} number of virtual resource blocks is formed by four columns and N_{row} rows. Here, N_{row} rows are defined as expressed by Equation 3 shown below:

N_{row}=┌Ñ_{VRB}^{DL}/(4P)┐·P [Equation 3]

In Equation 3, P value described in Table 2 shown below, indicating the size of a resource block group (RBG).

TABLE 2

| System bandwidth (N_{RB}^{DL}) | RBG size (P) |
|---|---|
| 1~10 | 1 |
| 11~26 | 2 |
| 27~63 | 3 |
| 64~110 | 4 |

Virtual resource blocks are written row by row and read column by column in the rectangular matrix constituting the interleaving unit. In particular, Nₙᵤₗₗ number of nulls are inserted into the last Nₙᵤₗₗ/2 rows of second and fourth columns. Here, Nₙᵤₗₗ is defined as expressed by Equation 4 shown below:

Nₙᵤₗₗ=4N_{row}−Ñ_{VRB}^{DL} [Equation 4]

When data is read from the rectangular matrix constituting the interleaving unit, nulls are not read but disregarded.

The number of physical resource blocks Ñ_{PRB} corresponding to virtual resources including interleaving according to a slot number nₛ is differently defined when the slot number is an odd number and when the slot number is an even number.

When the slot number nₛ is an even number, the number of physical resource blocks ñ_{PRB} is defined as expressed by Equation 5 shown below:

$$[ Equation 5 ]$$

$${\tilde{n}}_{PRB} ( {n}_{s} ) = \{ \begin{matrix}{\tilde{n}}_{PRB}^{′} - {N}_{row} , & {N}_{null} \neq 0 and {\tilde{n}}_{VRB} \geq {\tilde{N}}_{VRB}^{DL} - {N}_{null} and {\tilde{n}}_{VRB} mod 2 = 1 \\ {\tilde{n}}_{PRB}^{′} - {N}_{row} + {N}_{null} / 2 , & {N}_{null} \neq 0 and {\tilde{n}}_{VRB} \geq {\tilde{N}}_{VRB}^{DL} - {N}_{null} and {\tilde{n}}_{VRB} mod 2 = 0 \\ {\tilde{n}}_{PRB}^{″} - {N}_{null} / 2 , & {N}_{null} \neq 0 and {\tilde{n}}_{VRB} < {\tilde{N}}_{VRB}^{DL} - {N}_{null} and {\tilde{n}}_{VRB} mod 4 \geq 2 \\ {\tilde{n}}_{PRB}^{″} , & otherwise\end{matrix}$$

In Equation 5, ñ_{PRB}′ and ñ_{PRB}″ are defined as expressed by Equation 6 shown below:

ñ_{PRB}′=2N_{row}·(ñ_{VRB} mod 2)+└ñ_{VRB}/2┘+Ñ_{VRB}^{DL}·└n_{VRB}/Ñ_{VRB}^{DL}┘

ñ_{PRB}″=N_{row}·(ñ_{VRB} mod 4)+└ñ_{VRB}/4┘+Ñ_{VRB}^{DL}└n_{VRB}/Ñ_{VRB}^{DL}┘ [Equation 6]

In Equation 6, ñ_{VRB} is defined as expressed by Equation 7.

ñ_{VRB}=n_{VRB} mod Ñ_{VRB}^{DL} [Equation 7]

In Equation 7, n_{VRB} is a number of virtual resource blocks obtained from a downlink scheduling allocation.

When the slot number is an odd number, it is defined as expressed by Equation 8 shown below:

ñ_{PRB}(nₛ)=(ñ_{PRB}(nₛ−1)+Ñ_{VRB}^{DL}/2)mod Ñ_{VRB}^{DL}+Ñ_{VRB}^{DL}·└n_{VRB}/N_{VRB}^{DL}┘ [Equation 8]

The number n_{PRB} of a physical resource block corresponding to virtual resource can be obtained from the number ñ_{PRB} of the physical resource block corresponding to the virtual resource including interleaving through Equation 9 shown below:

$${n}_{PRB} ( {n}_{s} ) = \{ \begin{matrix}{\tilde{n}}_{PRB} ( {n}_{s} ) , & {\tilde{n}}_{PRB} ( {n}_{s} ) < {\tilde{N}}_{VRB}^{DL} / 2 \\ {\tilde{n}}_{PRB} ( {n}_{s} ) + {N}_{gap} - {\tilde{N}}_{VRB}^{DL} / 2 , & {\tilde{n}}_{PRB} ( {n}_{s} ) \geq {\tilde{N}}_{VRB}^{DL} / 2\end{matrix} \qquad [ Equation 9 ]$$

Through the foregoing process, the number of physical resource blocks can be derived from the virtual resource block ñ_{PRB}.

In the foregoing process, information to be obtained from the exterior in order to derive the number of the physical resource blocks from the number of virtual resource blocks is information regarding the number N_{RB}^{DL} of resource blocks and a gap value N_{gap}. In particular, information regarding the gap value N_{gap} is information as to whether the gap value is N_{gap}=N_{gap,1} or N_{gap}=N_{gap,2}. When the variable values are determined, other variables can be internally derived by using the determined variable values. Thus, information regarding the number N_{RB}^{DL} of resource blocks and the gap value N_{gap} may be called external variables, and other variables may be called internal variables.

With the number N_{RB}^{DL} of the entire resource blocks, resources may be allocated through the foregoing process, and only with some resource blocks, resources may be allocated through the foregoing process. Table 3 below shows the number N_{RB}^{DL} of resource blocks with respect to each transmission system bandwidth proposed in the LTE standard.

TABLE 3

| | Transmission system bandwidth [MHz] | | | | | |
|---|---|---|---|---|---|---|
| | 1.4 | 3 | 4 | 10 | 15 | 20 |
| Number of resource blocks | 6 | 15 | 25 | 50 | 75 | 100 |
| (N_{RB}^{DL}) | | | | | | |

In general, when physical resources are allocated to each virtual resource block, every foregoing process must be performed within 1 ms. Here, when the amount of calculations for physical resource allocation is taken into consideration, the apparatus for physical resource allocation is required to have a high level of hardware performance.

As described above, a table showing a state of physical resource allocation with respect to virtual resources derived by internal variables which can be calculated according to external variable and external variables may be created in advance. Also, by utilizing the previously created table, external variables may be received and internal variables required for referring to the table may be separately calculated. The allocation of physical resources by referring to the table can reduce the amount of calculation and improve the speed of physical resource allocation.

In addition, the table for physical resource allocation is extremely small when it is considered over the size of storage devices required for an established system, obtaining enhancement of excellent performance by simply adding a small amount of hardware.

Thus, the present invention proposes an apparatus for calculating internal information upon receiving the external information and allocating physical resources by referring to the table.

The apparatus for allocating physical resources according to an embodiment of the present invention will now be described.

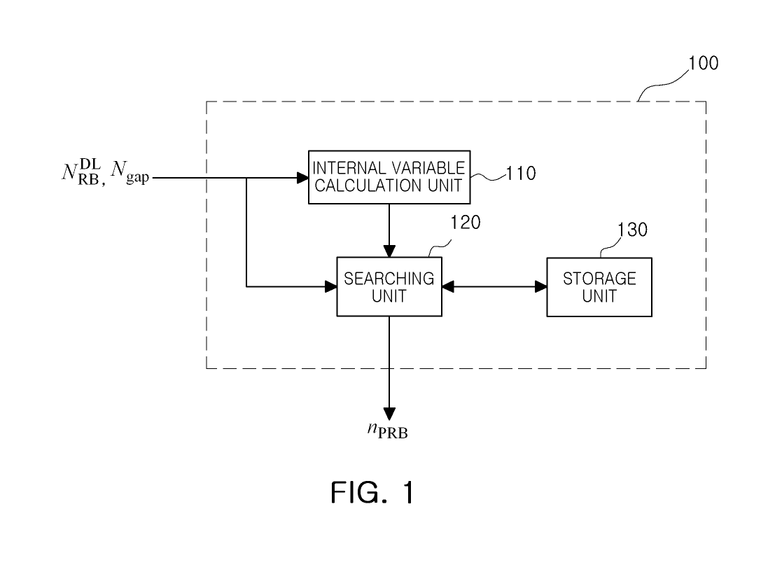

FIG. 1 is a schematic functional block diagram of an apparatus for allocating physical resources (referred to as “physical resource allocation apparatus”, hereinafter) according to an embodiment of the present invention.

With reference to FIG. 1, the physical resource allocation apparatus 100 may include an internal variable calculation unit 110, a searching unit 120, and a storage unit 130.

The internal variable calculation unit 110 may receive external variables for allocating physical resource blocks and calculate internal variables determined by the external variables. In particular, the external variables are information regarding the number N_{RB}^{DL} of resource blocks and a gap value N_{gap}. Also, information regarding the gap value N_{gap} is information as to whether the gap value is N_{gap}=N_{gap,1} or N_{gap}=N_{gap,2}, the results of downlink scheduling allocation of an upper layer.

The internal variables derived by the internal variable calculation unit 110 by using the external variables are the number of rows (Nrow) in the interleaving unit and the number of nulls (Nnull). The number of rows (Nrow) in the interleaving unit can be calculated by using the number of virtual resources Ñ_{VRB}^{DL} within the interleaving unit. Also, the number of nulls (Nnull) can be calculated by using the number of rows. (Nrow) of the interleaving unit and the number of virtual resources Ñ_{VRB}^{DL} within the interleaving unit.

The internal variable calculation unit 110 calculates the number of virtual resources Ñ_{VRB}^{DL} within the interleaving unit by using the number of virtual resource blocks N_{VRB}^{DL}.

The respective-internal variables can be calculated by using the number of resource blocks N_{RB}^{DL} and the gap value N_{gap}, external variables. Thus, eventually, a correspondence relationship between the virtual resource block n_{VRB} and the physical resource block n_{PRB} can be extracted by only the values of the external variables and can be configured as a table and stored.

The storage unit 130 may store the correspondence relationship between the virtual resource block n_{VRB} and the physical resource block n_{PRB} based on external variables.

The searching unit 120 may refer to the storage unit 130 by using the received external variables, search for the physical resource block n_{PRB} corresponding to the virtual resource block n_{VRB} and allocate the searched physical resource block n_{PRB}.

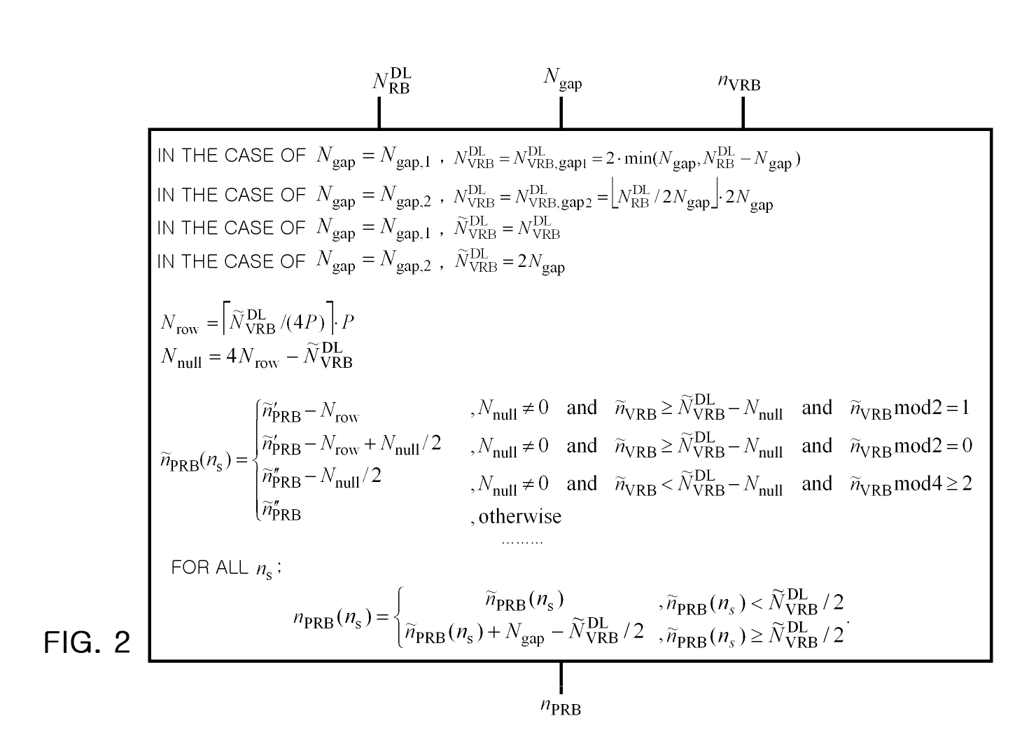

FIG. 2 is a view showing the physical resource allocation apparatus according to an embodiment of the present invention, expressed as functions.

With reference to FIG. 2, the physical resource allocation apparatus 100 may process a physical resource allocation by software or hardware by using Equation 1 to Equation 9. Also, if necessary, the physical resource allocation apparatus 100 may have content of Table 1 and Table 2 by storing the content in a storage unit or an additional register or the like.

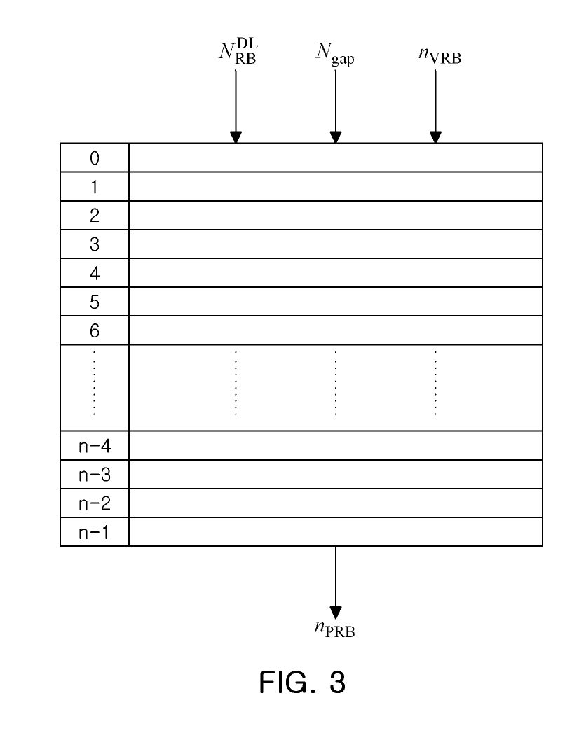

FIG. 3 is a schematic view showing a scheme for allocating physical resources by the physical resource allocation apparatus according to an embodiment of the present invention.

With reference to FIG. 3, the physical resource allocation apparatus 100 allocates the physical resource block n_{PRB} corresponding to every virtual resource block n_{VRB}. If necessary, the physical resource allocation apparatus 100 may allocate the physical resource block n_{PRB} corresponding only to some of the virtual resource blocks n_{VRB}.

When the physical resource block n_{PRB} is allocated, the searching unit 120 searches the table stored in the storage unit 130 for the physical resource block n_{PRB} corresponding to the virtual resource blocks n_{VRB} by using the number N_{RB}^{DL} of resource blocks and a gap value N_{gap}, and allocates the physical resource block n_{PRB}.

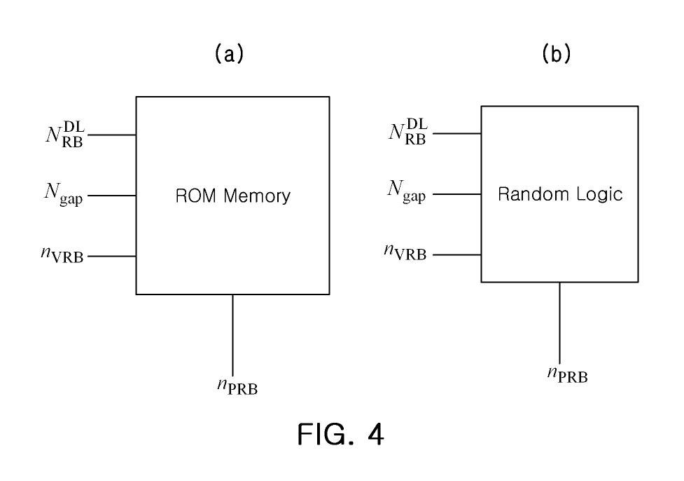

FIG. 4 is a view showing a storage unit of the physical resource allocation apparatus according to an embodiment of the present invention, implemented by hardware.

With reference to FIG. 4, the storage unit 130 of the physical resource allocation apparatus 100 may be implemented as a ROM or a random logic.

In the case of a ROM, when the number of resource blocks N_{RB}^{DL}, the gap value N_{gap}, and the virtual resource block n_{VRB}, which are an address value, are input, the physical resource block n_{PRB}, a storage value of the address value, is output.

In the case of a random logic, when the number of resource blocks N_{RB}^{DL}, the gap value N_{gap}, and the virtual resource block n_{VRB}, which are a logic input value, are input, the physical resource block n_{PRB}, a logic output value, is output.

As set forth above, according to embodiments of the invention, by referring to the correspondence relationship between the virtual resource blocks and the physical resource blocks stored in the storage unit, a physical resource block corresponding to a virtual resource block can be allocated at high speed.

While the present invention has been shown and described in connection with the embodiments, it will be apparent to those skilled in the art that modifications and variations can be made without departing from the spirit and scope of the invention as defined by the appended claims.

What is claimed is:

1. An apparatus for allocating physical resources, the apparatus comprising:
a storage unit storing correspondence relationships between virtual resource blocks and physical resource blocks according to external variables and internal variables;
an internal variable calculation unit receiving the external variables for allocating physical resource blocks and calculating internal variables determined by the received external variables; and
a searching unit referring to the storage unit by using the received external variables and allocating physical resources corresponding to the virtual resource blocks.

2. The apparatus of claim 1, wherein the apparatus is an apparatus for obtaining LTE/LTE-Advanced physical resources, and the internal variable calculation unit generates the number of rows (Nrow) and number of nulls (Nnull) of interleaving units.

3. The apparatus of claim 2, wherein the storage unit is implemented as a read only memory (ROM) or a random logic.

4. The apparatus of claim 2, wherein the internal variable calculation unit calculates the number of rows (Nrow) of the interleaving unit by using the number of virtual resources Ñ_{VRB}^{DL} within the interleaving unit, and calculates the number of nulls (Nnull) by using the number of rows (Nrow) of the interleaving unit and the number of virtual resources Ñ_{VRB}^{DL} within the interleaving unit.

5. The apparatus of claim 4, wherein the internal variable calculation unit calculates the number of virtual resources Ñ_{VRB}^{DL} within the interleaving unit and a gap value N_{gap} by using the number of the distribution type virtual resource blocks N_{VRB}^{DL}.

6. The apparatus of claim 2, wherein the external variables are information regarding the number of resource blocks N_{RB}^{DL} and the gap value N_{gap}.

7. The apparatus of claim 6, wherein the information regarding the gap value is information regarding whether N_{gap}=N_{gap,1} or N_{gap}=N_{gap,2}, the results of downlink scheduling allocation of an upper layer.
